(19) United States
(12) Patent Application Publication
(10) Pub. No.: US 2016/0048482 A1
(43) Pub. Date: Feb. 18, 2016

(54) METHOD FOR AUTOMATICALLY PARTITIONING AN ARTICLE INTO VARIOUS CHAPTERS AND SECTIONS

(71) Applicant: Golden Board Cultural anf Creative Ltd., Co., Taipei City (TW)

(72) Inventor: Yin-Hao Tsui, Taipei City (TW)

(21) Appl. No.: 14/729,891

(22) Filed: Jun. 3, 2015

(30) Foreign Application Priority Data
Aug. 18, 2014 (TW) 103128360

(51) Int. Cl. G06F 17/21; G06F 17/30

(52) U.S. Cl. CPC G06F 17/217; G06F 17/3053; G06F 17/212

(57) ABSTRACT

A method for automatically partitioning an article into various chapters and sections is provided and applicable for a digital article. Firstly, style combinations of a plurality of paragraphs of the digital article are recognized. Then, one or more paragraph features of the paragraphs having different style combinations are calculated. The paragraph feature may be the uniform distribution of paragraphs, the font size, the average number of words, the average paragraph spacing, or the combinations thereof. Hence, in accordance with each of the paragraph features, the style combinations are ranked. Then, a weighted average value is calculated according to the ranking of each the style combinations corresponding to the corresponding paragraph feature. And, paragraphs with weighted average values ranked in the first place are selected to be a plurality of candidate partition paragraphs. Lastly, the digital article is divided into a plurality of partitions according to the candidate partition paragraphs.

### CROSS-REFERENCES TO RELATED APPLICATIONS

This non-provisional application claims priority under 35 U.S.C. §119(a) on Patent Application No. 103128360 filed in Taiwan, R.O.C. on 2014 Aug. 18, the entire contents of which are hereby incorporated by reference.

### BACKGROUND

1. Technical Field

The instant disclosure relates to an article partition method, in particular, to a method for automatically partitioning an article into various chapters and sections and the method is applicable to a digital article.

2. Related Art

As technology advances, the use of portable electronic devices (e.g., tablet computers, mobile phones, etc.), is becoming increasingly widespread. The portable electronic devices are commonly applied for net surfing or for reading electronic books. As a result, since the need of the digital books is largely increased, the book publishers and ordinary authors are also starting to publish digital books in addition to the traditional physical books.

To help the reader to understand the brief structure of the book, the book may have a table of content. Many document editing software, for example the WORD software developed by Microsoft Company, may have a chapter and section editing function, however most users do not familiar with this function. If a digital article is lack of the chapter and section formatting, the publisher or the author would have to find out the title and the page number for each partition (i.e., each chapter or each section) of the digital article to make a table of content by their own, resulting in inconvenience in publish and prolonging the time for publishing the article. Therefore, the time for digital publication would be reduced if the table of the content for each partition can be generated automatically.

### SUMMARY

To address the issues, the instant disclosure provides a method for automatically partitioning an article into various chapters and sections, such that a table of content can be obtained.

An exemplary embodiment of the instant disclosure provides a method for automatically partitioning an article into various chapters and sections in which the method is applicable to a digital article. In the method, firstly a style combination of each of a plurality of paragraphs of the digital article is recognized. Next, one or more paragraph features of the paragraphs having different style combinations are calculated, wherein the paragraph feature may be the uniform distribution of paragraphs, the font size, the average number of words, the average paragraph spacing, or any combination thereof. Then, the style combinations are ranked according to each of the paragraph features. Thereafter, a weighted average value of each of the style combinations is calculated according to the ranking of each of the paragraph feature. And, paragraphs with average weighted values of the style combination thereof ranked in the first place are selected to be a plurality of candidate partition paragraphs. Last, the digital article is divided into a plurality of partitions according to the candidate partition paragraphs. Here, the style combination may comprise font size, bold font, italic font, first line indentation, alignment, underline, or any combination thereof.

In one implementation aspect, the number of paragraphs of each of the style combinations is calculated, and the style combinations each having one paragraph are deleted and the style combinations having the greatest number of paragraphs are also deleted. Moreover, the style combinations with the average number of words greater than a threshold value and the style combinations with the average number of words less than or equal to one are deleted. Accordingly, those paragraphs impossible to be the partition paragraphs may be eliminated preferentially, and the burden for calculating the paragraph features can be reduced. Therefore, after those paragraphs impossible to be the partition paragraphs are eliminated, in the step of calculating one or more paragraph features of the paragraph having different style combinations, the calculation would be based on the residual style combinations.

In one implementation aspect, when the paragraph feature comprises the uniform distribution of paragraphs, the paragraphs can be averagely divided into a plurality of groups, and the proportion of the groups having the style combination over all the groups according to each of the style combinations may be calculated to obtain the uniform distribution of paragraphs for each of the style combinations.

In one implementation aspect, the style combinations are ranked according to the types of the paragraph features. Specifically, when the paragraph feature comprises the uniform distribution of paragraphs, the uniform distribution of paragraphs is ranked in descendant order. When the paragraph feature comprises the font size, the font size is ranked in descendant order. When the paragraph feature comprises the average number of words, the average number of words is ranked in ascendant order based on the difference between the average number of words and a default number of words. When the paragraph feature comprises the average paragraph spacing, the average paragraph spacing is ranked in descendant order.

In one implementation aspect, after the digital article is divided into several partitions, the partitions may be further stored as a plurality of document files.

Based on the above, the method for automatically partitioning an article into various chapters and sections can be applied to a digital article to automatically recognize the positions (i.e., the page and the line) of the section paragraphs and the chapter paragraphs, such that the table of content of the digital article can be generated automatically.

Detailed description of the characteristics and the advantages of the disclosure is shown in the following embodiments, the technical content and the implementation of the disclosure should be readily apparent to any person skilled in the art from the detailed description, and the purposes and the advantages of the disclosure should be readily understood by any person skilled in the art with reference to content, claims and drawings in the disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 is a flowchart of a method for automatically partitioning an article into various chapters and sections according to an exemplary embodiment of the instant disclosure;

FIG. 2 is a schematic view of a digital article applicable for the method of the instant disclosure; and

FIG. 3 is a schematic view illustrating how the uniform distribution of paragraphs of the digital article is calculated according to the method of the instant disclosure.

### DETAILED DESCRIPTION

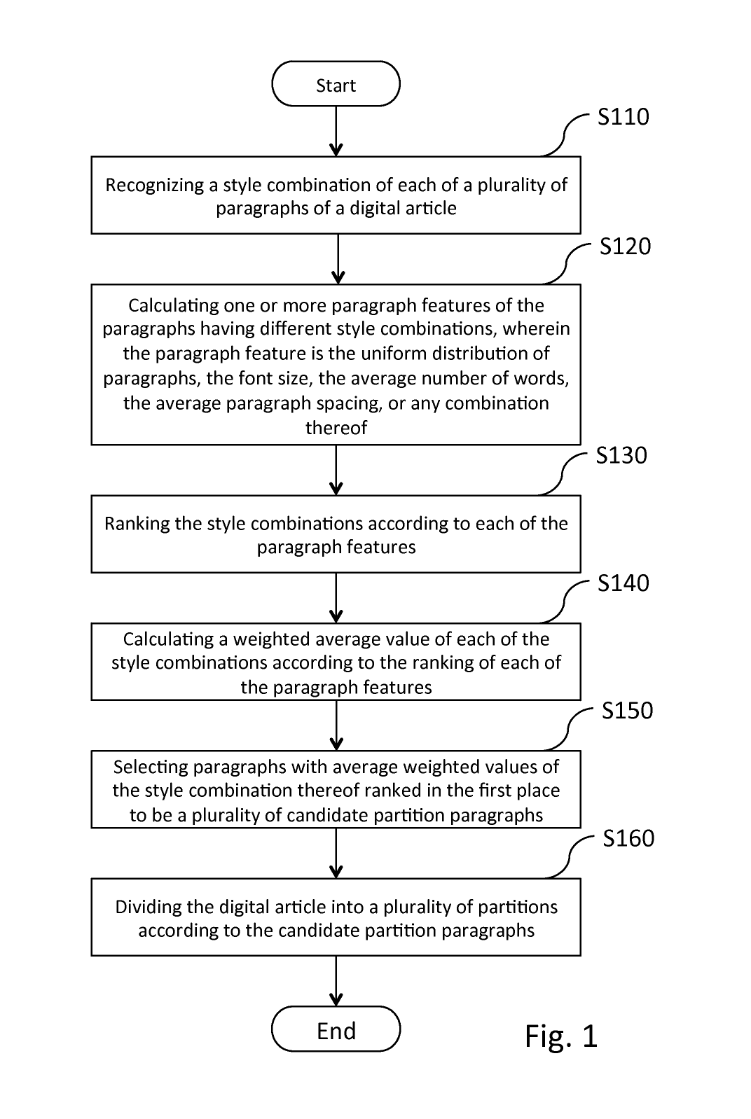

Please refer to FIG. 1, illustrating a flowchart of a method for automatically partitioning an article into various chapters and sections according to an exemplary embodiment of the instant disclosure. The method for automatically partitioning an article into various chapters and sections is applicable to digital articles. The digital articles are digital text files supportable for style setting, for example, the digital articles may be HTML files, WORD document files developed by Microsoft Company, PDF files developed by Adobe systems, RTF files, etc. These digital text files can be edited by document processing software; alternatively, an OCR (optical character recognition) procedure may be applied to recognize scanned graphic files to generate the digital text files. Details about how to generate digital text files are described in U.S. patent application Ser. No. 14/700,221 entitled “METHOD FOR GENERATING REFLOW-CONTENT ELECTRONIC BOOK AND WEBSITE SYSTEM THEREOF”, which is incorporated by reference herein in its entity. In the disclosure, details about how to partition a digital article according to the content of the digital article are described.

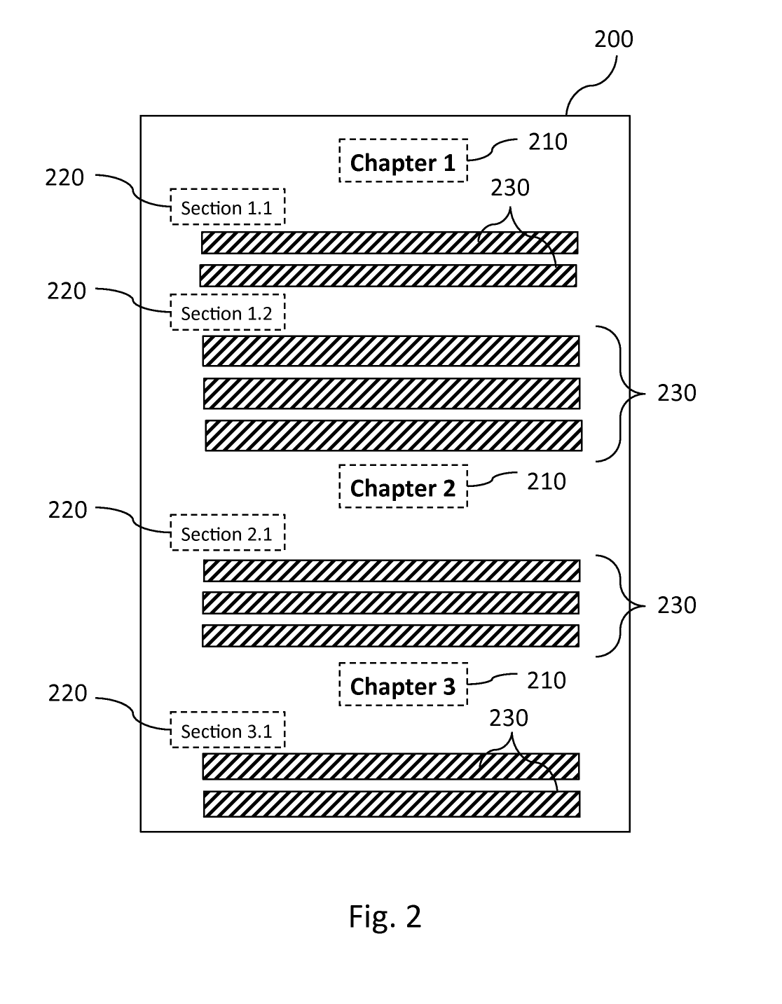

FIG. 2 is a schematic view of a digital article 200 applicable for the method of the instant disclosure. As shown in FIG. 2, the digital article 200 comprises a plurality of paragraphs. The paragraphs may be, but not limited to, chapter paragraphs 210 (or called chapter titles), section paragraphs 220 (or called section titles), or content paragraphs 230. Alternatively, the paragraphs may only include chapter paragraphs 210 and content paragraphs 230, or the paragraphs may include paragraphs in various paragraph types (e.g., subsection paragraphs). In general, paragraphs with same paragraph type would have the same or similar style combinations. The style combination may comprises, but not limited to, font size, bold font, italic font, first line indentation, alignment (e.g., align text left, align text central, and align text right), underline, or any combination thereof. Therefore, by recognizing the number of the paragraph types, the number of the words, and the extent of paragraph dispersion, candidate partition paragraphs (i.e., the candidate partition paragraphs are paragraphs to be section paragraphs or chapter paragraphs) can be figured out. The term “any combination” of a group may be referred to one, more than one, or all the elements of the group. For example, the style combination may only include font size, or may include font size and other parameters (e.g., alignment).

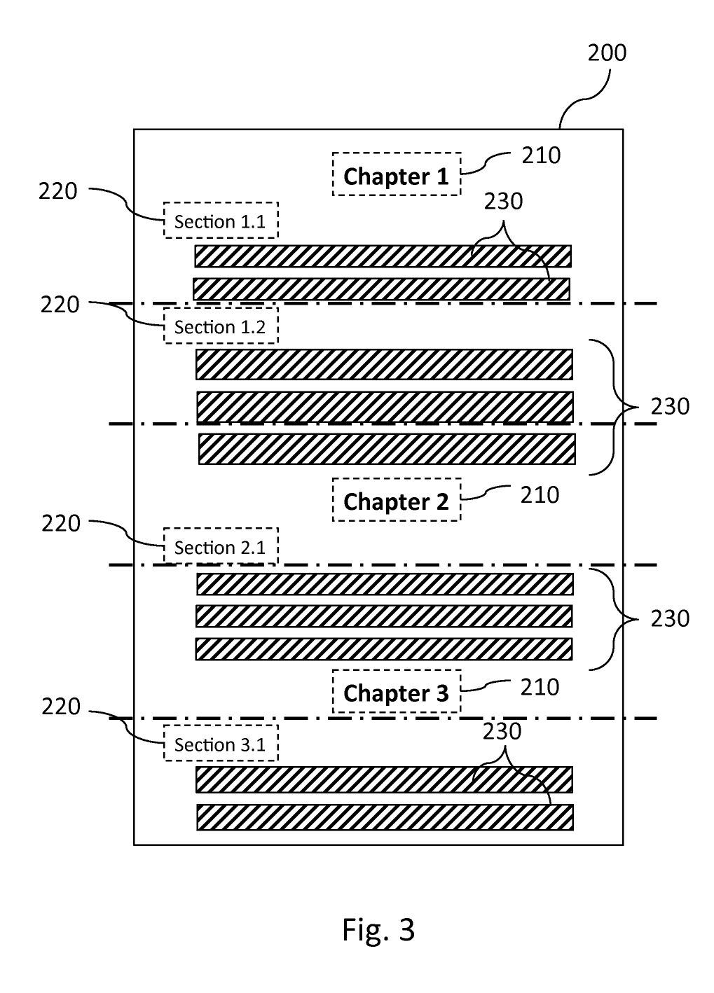

As shown in FIG. 2, in this embodiment, the chapter paragraph 210 is bold, and central aligned, with the font size in 18 points; the section paragraph 220 is left aligned, with the font size in 16 points. For the sake of clarity in presenting the content paragraphs 230 in FIGS. 2-3, instead of showing the texts in the content paragraphs 230 practically, one block with slanting stripes are used to represent one content paragraph 230. A content paragraph 230 may comprise a plurality of lines of words. Here, the content paragraphs 230 are left aligned, two character indentation, and the font size is 12 points.

Please refer to FIG. 1 again, in step S110, the style combination of each of the paragraphs of the digital article 200 is first recognized. Therefore, the three aforementioned paragraph types (i.e., chapter paragraph 210, section paragraph 220, and content paragraph 230) of the digital article 200 can be recognized.

Next, in step S120, one or more paragraph features of the paragraphs having different style combinations are calculated. The paragraph feature may be the uniform distribution of paragraphs, the font size, the average number of words, the average paragraph spacing, or any combination thereof. The average number of words is a mean value of the words of paragraphs with the same paragraph type. The paragraph spacing is the spacing between adjacent paragraphs. The average paragraph spacing is a mean value of the paragraph spacing between paragraphs with the same paragraph type. The uniform distribution of paragraphs is the distribution of paragraphs for each paragraph type. In general, the section paragraphs 220 or the chapter paragraphs 210 would not be too concentrate in a certain region of the article. Therefore, the uniform distribution of paragraphs is one of the important factors for recognizing the section paragraphs 220 and the chapter paragraphs 210 (i.e., the partition paragraphs).

As shown in FIG. 3, a schematic view illustrates how the uniform distribution of paragraphs of the digital article 200 is calculated according to the method. In the calculation of the uniform distribution of paragraphs, the paragraphs of the digital article 200 are firstly divided into a plurality of groups averagely. Next, for each of the style combinations, the proportion of the groups having the style combination over all the groups are calculated, such that the uniform distribution of paragraphs of the paragraphs having different style combinations can be calculated. If the digital article 200 is divided into N parts averagely, N will be a positive integer greater than 1. Here, the digital article 200 is divided into five parts (i.e., the digital article 200 are separated by four chain lines). As shown, the chapter paragraphs are shown in three of the five groups, the section paragraph are shown in four of the five groups, and the content paragraph are shown in all the five groups. Therefore, the content paragraphs 230 have the highest uniform distribution of paragraphs over the digital article 200 (i.e., the content paragraphs 230 are distributed over the whole digital article 200 uniformly), chapter paragraphs 210 have the lowest uniform distribution of paragraphs over the digital article 200, and the section paragraphs 220 have moderate uniform distribution of paragraphs over the digital article 200. Consequently, according to the uniform distribution of paragraphs, those paragraphs which are not partition paragraphs can be preferentially eliminated. While other paragraph features (e.g., font size) would be concerned integrally with the uniform distribution of paragraphs for finding which paragraphs are section paragraphs 220 and which are chapter paragraphs 210.

Therefore, after step S120, the style combinations are ranked according to each of the paragraph features (i.e., the step S130). If the paragraph feature is the uniform distribution of paragraphs, the uniform distribution of paragraphs would be ranked in descendant order. If the paragraph feature is the font size, the font size would be ranked in descendant order. If the paragraph feature is the average number of words, the average number of words would be ranked in ascendant order based on the difference between the average number of words and a default number of words. If the paragraph feature is the average paragraph spacing, the average paragraph spacing would be ranked in descendant order. However, embodiments are not thus limited thereto. The ranking of the style combination can be adjusted according to the typesetting of the digital article 200.

Then, in step S140, a weighted average value of each of the style combinations is calculated according to the ranking of each of the paragraph features. In other words, the weighted average value is obtained by multiplied the ranking of each paragraph feature with a weight based on the importance of each of the paragraph features.

Hence, in the step S150, paragraphs with average weighted values of the style combination thereof ranked in the first place are selected to be a plurality of candidate partition paragraphs (i.e., candidate section paragraphs and candidate chapter paragraphs). Last, the digital article 200 is divided into a plurality of partitions (i.e., sections and chapters) according to the positions of the candidate partition paragraphs (i.e., step S160). Also, the table of content can be generated according to the positions of the candidate partition paragraphs.

In one embodiment, before the step S120, the number of paragraphs of each of the style combinations is calculated. And then, because the number of the partition paragraphs would not be only one in general, the style combinations having one paragraph are deleted. In addition, the style combinations having the greatest number of paragraphs are deleted, so that the content paragraphs 230 can be eliminated from the candidate partition paragraphs. Moreover, because the number of words of the section paragraph 220 (or the chapter paragraph 210) would not be too many, the style combinations with the average number of words greater than a threshold value and the style combinations with the average number of words less than or equal to one are deleted. Based on the above, those paragraphs impossible to be the partition paragraphs may be eliminated, and the burden for calculating the paragraph features can be reduced. Therefore, after those paragraphs impossible to be the partition paragraphs are eliminated, in the step of calculating one or more paragraph features of the paragraph having different style combinations, the calculation would be based on the residual style combinations.

The method for automatically partitioning an article into various chapters and sections may be carried out by a website server, and a user may login the website server via internet. When the digital article 200 is uploaded by a user terminal (e.g., a personal computer, a smart phone, etc.), the website server would execute the method for automatically partitioning an article into various chapters and sections to divide the digital article 200 into several partitions according to the section titles or chapter titles of the digital article 200. After the article division, the partitions may be saved as several document files, or a content of table may be generated according to the section titles and chapter titles.

In the forgoing embodiment, the writing direction of the digital article 200 is transverse, but embodiments are not limited thereto. Alternatively, the method for automatically partitioning an article into various chapters and sections may be applied to a digital article 200 whose writing direction is vertical.

Based on the above, the method for automatically partitioning an article into various chapters and sections can be applied to a digital article to automatically recognize the positions (i.e., the page and the line) of the section title and the chapter title, such that the table of content of the digital article can be generated automatically.

While the instant disclosure has been described by way of example and in terms of the preferred embodiments, it is to be understood that the invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. An method for automatically partitioning an article into various chapters and sections, applicable to a digital article, the method comprising:
recognizing a style combination of each of a plurality of paragraphs of the digital article;
calculating one or more paragraph features of the paragraphs having different style combinations, wherein the paragraph feature is the uniform distribution of paragraphs, the font size, the average number of words, the average paragraph spacing, or any combination thereof;
ranking the style combinations according to each of the paragraph features;
calculating a weighted average value of each of the style combinations according to the ranking of each of the paragraph features;
selecting paragraphs with average weighted values of the style combination thereof ranked in the first place to be a plurality of candidate partition paragraphs; and
dividing the digital article into a plurality of partitions according to the candidate partition paragraphs.

2. The method for automatically partitioning an article into various chapters and sections according to claim 1, further comprising:
calculating the number of paragraphs of each of the style combinations;
deleting the style combinations each having one paragraph; and
deleting the style combinations having the greatest number of paragraphs.

3. The method for automatically partitioning an article into various chapters and sections according to claim 2, wherein in the step of calculating one or more paragraph features of the paragraphs having different style combinations, the calculation is based on the residual style combinations.

4. The method for automatically partitioning an article into various chapters and sections according to claim 1, wherein when the paragraph feature comprises the uniform distribution of paragraphs, the step of calculating one or more paragraph features of the paragraphs having different style combinations comprises:
dividing the paragraphs averagely into a plurality of groups; and
calculating the proportion of the groups having the style combination over all the groups according to each of the style combinations.

5. The method for automatically partitioning an article into various chapters and sections according to claim 1, further comprising:
deleting the style combinations with the average number of words greater than a threshold value and the style combinations with the average number of words less than or equal to one.

6. The method for automatically partitioning an article into various chapters and sections according to claim 1, wherein the step of ranking the style combinations according to each of the paragraph features comprises:
ranking the uniform distribution of paragraphs in descendant order when the paragraph feature comprises the uniform distribution of paragraphs;
ranking the font size in descendant order when the paragraph feature comprises the font size;
ranking the average number of words in ascendant order based on the difference between the average number of words and a default number of words when the paragraph feature comprises the average number of words; and
ranking the average paragraph spacing in descendant order when the paragraph feature comprises the average paragraph spacing.

7. The method for automatically partitioning an article into various chapters and sections according to claim 1, further comprising:
storing the partitions as a plurality of document files.

8. The method for automatically partitioning an article into various chapters and sections according to claim 1, wherein the style combination comprises font size, bold font, italic font, first line indentation, alignment, underline, or any combination thereof.
